(19) United States
(12) Patent Application Publication
(10) Pub. No.: US 2009/0167888 A1
(43) Pub. Date: Jul. 2, 2009

(54) METHODS OF PROCESSING IMAGING SIGNAL AND SIGNAL PROCESSING DEVICES PERFORMING THE SAME

(76) Inventor: Yo-Hwan NOH, Seoul (KR)

Correspondence Address: BIRCH STEWART KOLASCH & BIRCH, PO BOX 747, FALLS CHURCH, VA, 22040-0747, US

(21) Appl. No.: 12/343,284

(22) Filed: Dec. 23, 2008

(30) Foreign Application Priority Data
Dec. 28, 2007 (KR) 10-2007-0140703
Dec. 28, 2007 (KR) 10-2007-0140704

(51) Int. Cl. H04N 5/228

(52) U.S. Cl. 348/222.1

(57) ABSTRACT

Methods of processing an image signal and signal processing devices can lessen a work load of a processor for processing a photographed image signal, can process photographed image signal, and can display the image signal in real time. The method includes performing first image processing on a first image frame to generate first image data, performing second image processing on the first image frame to generate second image data, outputting the first image data based on a first vertical synchronization signal, causing image processing not to be performed on a second image frame subsequent to the first image frame, and outputting the second image data. Accordingly, the JPEG image and the thumbnail image for the photographed image are generated by the image signal processor, thereby lessening a work load of the processor and improving image processing speed.

### CROSS-REFERENCE TO RELATED APPLICATION

This application claims the benefit of Korean Patent Application No. 2007-0140703, filed on Dec. 28, 2007, and Korean Patent Application No. 2007-0140704, filed on Dec. 28, 2007, which are hereby incorporated by reference as if filly set forth herein.

### BACKGROUND

1. Technical Field

The present invention relates to signal processing devices, and more particularly, to methods of processing an image signal that can be performed in a signal processing device for processing a photographed image, and signal processing devices performing the same.

2. Discussion of Related Art

Current imaging devices having large-capacity pixels mounted on portable terminals, such as cell phones, Personal Digital Assistants (PDAs), Portable Multimedia Players (PMPs), and the like, enable the portable terminals to photograph images or movies with quality comparable to digital cameras.

FIG. 1 is a block diagram of a typical imaging device.

Referring to FIG. 1, an imaging device is generally mounted on a portable terminal, and includes an image sensor 11, an image signal processor 13, a back-end processor 15, a memory 17, and a display unit 19.

The image sensor 11 may be a Charge Coupled Device (CCD) or Complementary Metal-Oxide Semiconductor (CMOS) image sensor having a Bayer pattern. In the image sensor 11, each pixel outputs an electrical signal corresponding to an amount of light input via a lens.

The image signal processor 13 converts the electrical signal (raw data) input from the image sensor 11 into a YUV value and provides the YUV value to the back-end processor 15. A YUV scheme uses the fact that people's eyes are more sensitive to luminance than to color, and divides the color into a Y component which is a luminance component and U and V components which are chrominance components. Since the Y component is sensitive to error, the Y component is encoded into a greater number of bits than the chrominance components U and V. A typical ratio of Y:U:V is 4:2:2.

The back-end processor 15 transforms the input YUV value into a Joint Photographic Experts Group (JPEG) image using a prescribed encoding scheme, and stores the JPEG image in the memory 17 or decodes the JPEG image and provides the decoded JPEG image to the display unit so that the photographed image may be displayed. The back-end processor 15 reads the JPEG image from the memory 17, decodes the JPEG image, generates a thumbnail image, and provides the thumbnail image to the display unit 19 or stores the thumbnail image into the memory 17.

The display unit 19 receives the decoded image signal or the thumbnail image signal from the back-end processor 15 and displays the decoded image signal or the thumbnail image signal.

In general, a thumbnail image (a reduced-size image) obtained by scaling down an original photographed image to a predetermined size is used to enable an image photographed by an imaging device to be immediately checked, or to enable an image that a user desires to display to be rapidly selected by being rapidly read from a memory when a plurality of images stored in the memory are read and displayed.

The thumbnail image is generated when a specific event, such as an event instructing to display a photographed image, is generated. For example, when the event instructing to display a photographed image is generated) the JPEG-encoded image is read from the memory, decoded, and scaled down to a prescribed size, resulting in a thumbnail image. The thumbnail image is displayed on the display unit. The generated thumbnail image, encoded into a JPEG format, may be stored in the memory.

The process of generating the thumbnail image in a portable terminal including the imaging device as shown in FIG. 1 is performed by the back-end processor or a multimedia processor.

However, since current image sensors have large-capacity pixels, the photographed image has a large data size. This increases a work load of the processor that read the JPEG image from the memory, decodes the read JPEG image and generates the thumbnail image, resulting in slow thumbnail-image generation and low thumbnail-image quality.

In order to generate the thumbnail image from the JPEG-encoded image, the JPEG-encoded data should be decoded and then stored in the memory. The capacity of the decoded data are at least twice as much as that of the JPEG-encoded data. Thus above mentioned thumbnail image generation method cannot be performed in a typical portable terminal due to the small-capacity memory of the portable terminal.

### SUMMARY

The present invention is directed to methods capable of processing a photographed image signal, which can lessen a work load of a processor for processing the image signal, and capable of processing the photographed image signal to display the image signal in real time.

The present invention is also directed to signal processing devices for performing above methods.

In some example embodiments, a method of processing an image signal by processing image frames provided from an image sensor and providing the processed image frames to a processor includes: performing first image processing on a first image frame to generate first image data; performing second image processing on the first image frame to generate second image data; outputting the first image data based on a first vertical synchronization signal; causing image processing not to be performed on a second image frame subsequent to the first image frame; and outputting the second image data. The performing of the first image processing on a first image frame to generate first image data may include generating the first image data scaled down by scaling the first image frame. The performing of the second image processing on the first image frame to generate second image data may include encoding the first image frame to generate the second image data compressed into a predetermined format. The outputting of the first image data based on a first vertical synchronization signal comprises temporarily storing the second generated image data. The method may further include outputting the second image data based on a third vertical synchronization signal for outputting the second image data after the first image data are output. The outputting of the second image data based on a third vertical synchronization signal may include: determining whether the first image data have been output; determining whether the second image data have been stored when the first image data has been output; and outputting the second image data based on the third vertical synchronization signal when the second image data have been stored.

In other example embodiments, a method of processing an image signal by processing image frames provided from an image sensor and providing the processed image frames to a processor includes: performing first image processing on a first image frame to generate first image data; performing second image processing on the first image frame to generate second image data; sequentially outputting the first and second image data; and blocking a second image frame from being input while the first and second image data are output, and receiving the second image frame when the first and second image data have been output. The sequentially outputting the first and second image data may include: outputting the first image data based on a first vertical synchronization signal; storing the second image data; and when the first image data has been output, reading the second stored image data and outputting the second image data following the first image data. The receiving of the second image frame when the first and second image data have been output may include generating a new vertical synchronization signal when the first and second image data have been output. The receiving of the second image frame when the first and second image data have been output may include: when a second vertical synchronization signal that is an input synchronization signal for the second image frame is generated while the first and second image data are being sequentially output based on the first vertical synchronization signal, delaying the second vertical synchronization signal to correspond to a vertical synchronization signal indicating that the second image data has been output, such that the second image frame may be blocked from being input while the first and second image data are being output.

In still another example embodiments, a signal processing device for processing image frames provided from an image sensor and providing the processed image frames to a processor includes: a first signal processor configured to perform first image processing on a first image frame to generate first image data; a second signal processor configured to perform second image processing on the first image frame to generate second image data; a controller configured to perform control operation such that the first image data may be output based on a first vertical synchronization signal and image processing may not be performed on a second image frame subsequent to the first image frame; and an output controller configured to output the first and second image data respectively provided from the first and second signal processors. The signal processing device further include: a pre-processor configured to output the first image frame based on the first vertical synchronization signal; and a frame memory configured to store the second image data under control of the controller. The controller may perform control operation such that the first image data may be output based on the first vertical synchronization signal and the second image data may be stored in the frame memory. When the first image data have been output and then the second image data have been stored in the frame memory, the output controller may read the second image data from the frame memory based on a third vertical synchronization signal and then may output the second read image data based on the third vertical synchronization signal. The first signal processor may generate the first image data scaled down by scaling the first image frame. The second signal processor may encode the first image frame to generate second image data compressed into a predetermined format.

In still another example embodiments, a signal processing device for processing image frames provided from an image sensor and providing the processed image frames to a processor include: a first signal processor configured to perform first image processing on a first image frame to generate first image data; a second signal processor configured to perform second image processing on the first image frame to generate second image data; an output controller configured to sequentially output the first and second image data; and a controller configured to perform control operation such that a second image frame may be blocked from being input while the first and second image data are being output and the second image frame may be input after the first and second image data have been output. The signal processing device may farther include: a pre-processor configured to receive the first image frame from the image sensor, configured to perform predetermined pre-processing, and configured to provide the first pre-processed image frame to the first and second signal processors; and a frame memory configured to store the second image data under control of the controller, wherein the controller perform control operation such that the first image data may be provided to the output controller and the second image data may be stored in the frame memory, based on the first vertical synchronization signal. The output controller may output the first image data based on the first vertical synchronization signal, may read the second stored image data, may output the second image data following the first image data, and may generate a new vertical synchronization signal when the first and second image data have been output. When a second vertical synchronization signal that is an input synchronization signal for the second image frame is generated while the first and second image data are being sequentially output based on the first vertical synchronization signal, the controller may delay the second vertical synchronization signal to correspond to a vertical synchronization signal indicating that the second image data have been output, such that the second image frame may be blocked from being input while the first and second image data are being output.

### BRIEF DESCRIPTION OF THE DRAWINGS

The above and other objects, features and advantages of the present invention will become more apparent to those of ordinary skill in the art by describing in detail example embodiments thereof with reference to the attached drawings, in which:

FIG. 1 is a block diagram of a typical imaging device;

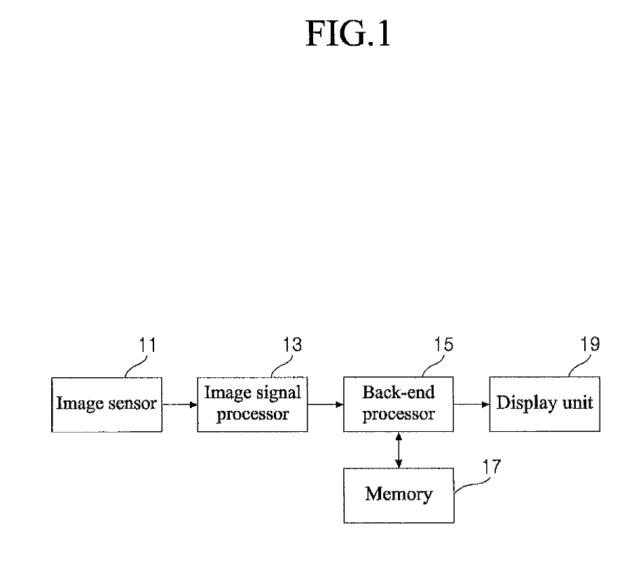

FIG. 2 is a block diagram of an imaging device according to an example embodiment of the present invention;

FIG. 3 is a timing diagram illustrating operation of an image signal processor according to an example embodiment of the present invention;

FIG. 4 is a timing diagram illustrating outputs of the image signal processor according to an example embodiment of the present invention;

FIG. 5 is a block diagram of an imaging device according to another example embodiment of the present invention; and

FIG. 6 is a timing diagram illustrating operation of an image signal processor according to another example embodiment of the present invention.

### DETAILED DESCRIPTION OF EXAMPLE EMBODIMENTS

The present invention will now be described more fully hereinafter with reference to the accompanying drawings, in which example embodiments of the invention are shown. This invention may, however, be embodied in many different forms and should not be construed as limited to the example embodiments set forth herein. It should be understood, however, that there is no intent to limit example embodiments to the particular forms disclosed, but on the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

The terminology used herein is for the purpose of describing particular example embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meanings as commonly understood by one of ordinary skill in the art to which this invention pertains. It will be further understood that terms defined in common dictionaries should be interpreted within the context of the relevant art and not in an idealized or overly formal sense unless expressly so defined herein.

Hereinafter, in order to more specifically describe example embodiments, various aspects will be described in detail with reference to the attached drawings. Like numbers refer to like elements throughout the description of the figures.

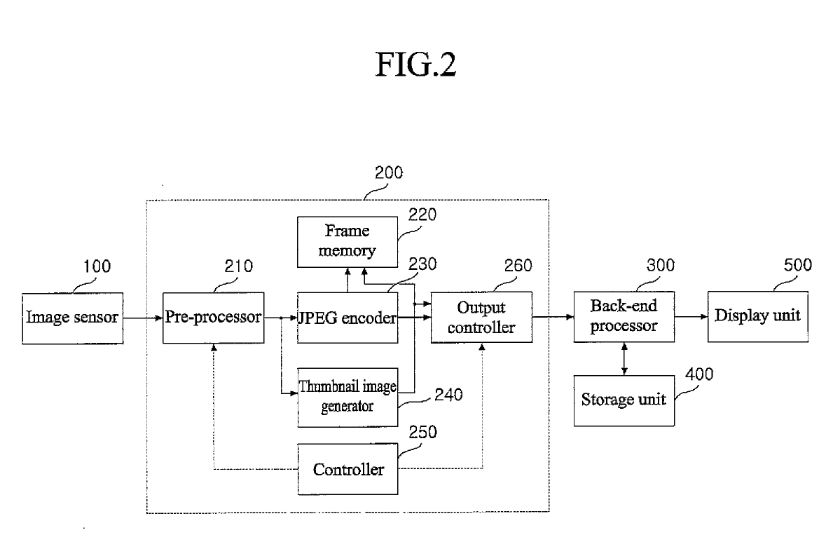

FIG. 2 is a block diagram of an imaging device according to an example embodiment of the present invention.

Referring to FIG. 2, the imaging device according to an example embodiment of the present invention includes an image sensor 100, an image signal processor 200, a back-end processor 300, a storage unit 400, and a display unit 500.

The image signal processor 200 includes a pre-processor 210, a frame memory 220, a JPEG encoder 230, a thumbnail image generator 240, a controller 250, and an output controller 260.

The image sensor 100 may be a Charge Coupled Device (CCD) or Complementary Metal-Oxide Semiconductor (CMOS) image sensor and have a Bayer pattern.

The image sensor 100 includes a plurality of pixels, each outputting raw image data corresponding to an amount of light that is input via a lens.

The pre-processor 210 receives the raw image data from the image sensor 100, performs pre-processing, such as color space transformation, filtering, color sub-sampling, and the like, on the received raw image data, and provides the processed image data to the JPEG encoder 230 and the thumbnail image generator 240.

Here, the pre-processor 210 provides the processed image data to the JPEG encoder 230 and the thumbnail image generator 240 on a frame-by-frame basis, based on a vertical synchronization signal and a valid data enable signal.

The color space transformation is a process of transforming an RGB color model into a YUV model to reduce an amount of data without image-quality degradation. The filtering process smoothes an image using a low pass filter to obtain a more visible image. The color sub-sampling is a process of down-sampling a chrominance signal component by using an entire Y value and by using other values in part, with a remainder of the other values discarded.

The frame memory 220 temporarily stores the JPEG image data output from the JPEG encoder 230 or the thumbnail image data output from the thumbnail image generator 240 under control of the controller 250.

The JPEG encoder 230 encodes the raw image data provided from the pre-processor 210 to generate the JPEG-compressed image.

That is, the JPEG encoder 230 performs Discrete Cosine Transform (DCT), quantization, and entropy encoding on the image data on a block by block basis (e.g., 8×8 pixels) to generate the JPEG image data. Since a JPEG encoding process is well known to those skilled in the art, a detailed description of the JPEG encoding process will be omitted.

The JPEG encoder 230 may store the generated JPEG image data in the frame memory 220 or provide the JPEG image data to the output controller 260 under control of the controller 250.

The thumbnail image generator 240 scales the raw image data provided from the pre-processor 210 to transform the raw image data to have a prescribed thumbnail image size and format. The thumbnail image generator 240 may include an image scaler for thumbnail image generation. The thumbnail image format may be a RGB or YUV format.

The thumbnail image generated by the thumbnail image generator 240 may be provided to the output controller 260 or stored in the frame memory 220 under control of the controller 250.

The controller 250 controls the JPEG image data and/or thumbnail image data provided to the output controller 260.

Specifically, the controller 250 controls the JPEG image data and/or thumbnail image data such that the thumbnail image data for the first image frame generated by the thumbnail image generator 240 may be provided to the output controller 260 based on a first vertical synchronization signal and the JPEG image data for the first image frame generated by the JPEG encoder 230 may be stored in the frame memory 220 based on a first vertical synchronization signal.

Alternatively, the controller 250 controls the JPEG image data and/or thumbnail image data such that the thumbnail image data for the first image frame may be stored into the frame memory 220 based on the first vertical synchronization signal and the JPEG image data for the first image frame may be provided to the output controller 260 based on the first vertical synchronization signal.

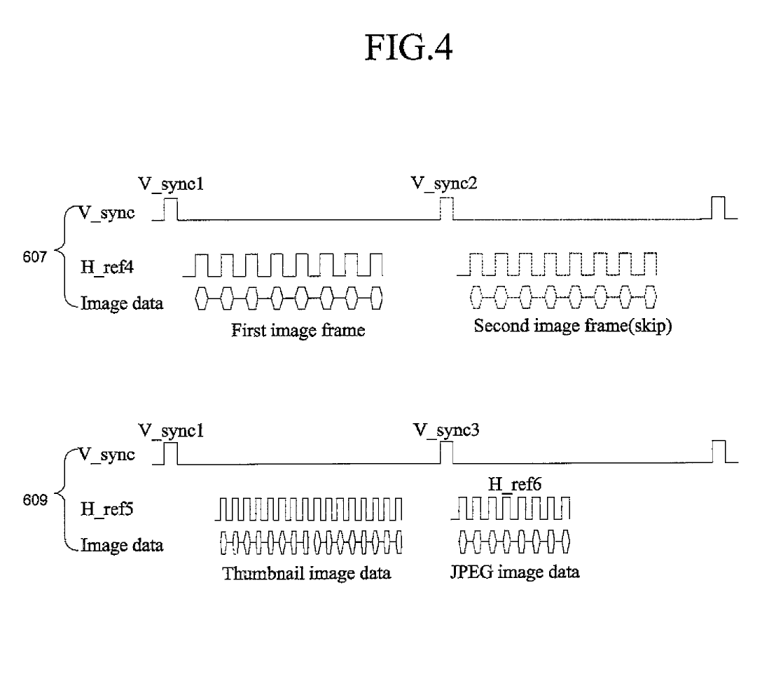

The controller 250 also controls the pro-processor 210 not to generate a second vertical synchronization signal V_sync2 (see FIG. 4) subsequent to the first vertical synchronization signal V_sync1 (see FIG. 4), thereby preventing a new image frame synchronized to the second vertical synchronization signal from being output from the pre-processor 210 while the thumbnail image data and the JPEG image data for the first image frame are being output via the output controller 260.

That is, the controller 250 controls the JPEG image data and/or thumbnail image data such that the thumbnail image data and/or JPEG image data for the second image frame may not be generated by not performing image processing on the second image frame following the first image frame.

Alternatively, the controller 250 may control the pre-processor 210 to ignore the second generated vertical synchronization signal, such that the image processing may not be performed on the second image frame. The output controller 260 serves to control a final output of the image signal processor 200 in cooperation with the controller 250. That is, the output controller 260 outputs the thumbnail image data for the first image frame based on the first vertical synchronization signal, determines whether the JPEG image data for the first image frame has been stored in the frame memory 220, generates a new vertical synchronization signal and a valid data enable signal when it is determined that the JPEG image data has been stored, reads the JPEG image data from the frame memory 220, and outputs the JPEG image data synchronized to the generated vertical synchronization signal and valid data enable signal.

The back-end processor 300 receives the JPEG image data from the output controller 260, stores the received JPEG image data in the storage unit 400 or decodes and provides the JPEG image data to the display unit 500 so that the JPEG image is displayed.

The back-end processor 300 receives the thumbnail image data from the output controller 260, and provides the thumbnail image data to the display unit 500 to directly display the thumbnail image or encodes the thumbnail image data to transform the thumbnail image data into a JPEG format and store the JPEG image data in the storage unit 400.

The back-end processor 300 includes a vertical synchronization signal V sync, a valid data enable signal H_ref, and a data interface in order to receive the JPEG image data and the thumbnail image data from the output controller 260 as described above, like a conventional back-end processor.

Thus, the image signal processor according to an example embodiment of the present invention can provide the JPEG image data and the thumbnail image data to the back-end processor, in real time, via the same interface as a conventional one.

The storage unit 400 stores the JPEG image data and/or the thumbnail image data under control of the back-end processor 300.

The display unit 500 may be, for example, a Liquid Crystal Display (LCD) or an Organic Light Emitting Diode (OLED), and displays the JPEG image or the thumbnail image provided by the back-end processor 300.

Although, in the image signal processor according to an example embodiment of the present invention shown in FIG. 2, the controller 250 controls the vertical synchronization signal to block the second image frame from being output from the pre-processor 210 while the thumbnail image data and the JPEG image for the first image frame are being output, the output controller 260 may control the vertical synchronization signal directly or in cooperation with the controller 250.

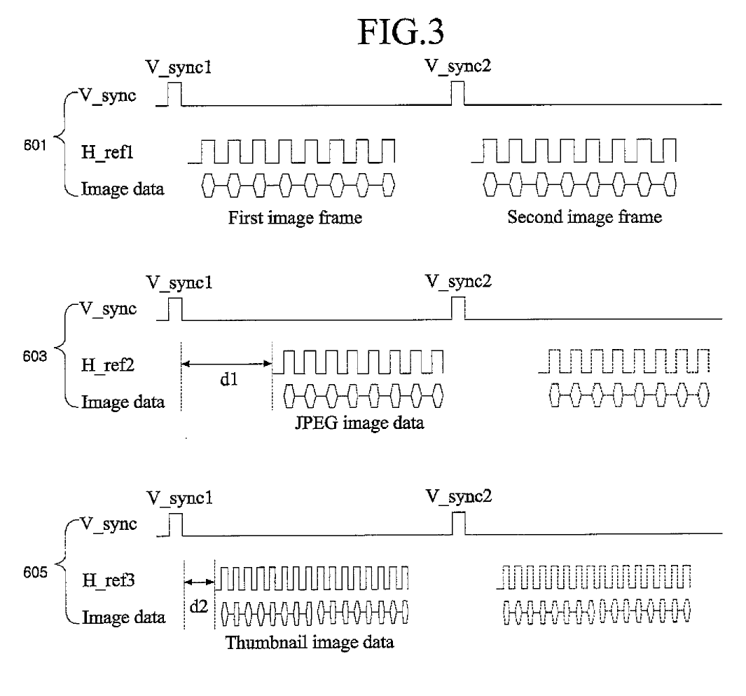

FIG. 3 is a timing diagram illustrating operation of the image signal processor, including an input 601 of the pre-processor, an output 603 of the JPEG encoder, and an output 605 of the thumbnail image generator, according to an example embodiment of the present invention.

Referring to FIG. 3, the pre-processor 210 receives the first image frame from the image sensor 100 based on a falling or negative edge of the first vertical synchronization signal V_sync1 and the valid data enable signal H_ref1. The pre-processor 210 also receives the second image frame from the image sensor 100 based on the second vertical synchronization signal V_sync2 and the valid data enable signal.

The JPEG encoder 230 encodes the first image frame provided from the pre-processor 210, generates the JPEG image data, and outputs the generated JPEG image data, based on the first vertical synchronization signal V_sync1 and the valid data enable signal H_ref2.

Here, the JPEG image data may be output after a delay time d1 lapses from the falling edge of the first vertical synchronization signal V_sync1. The delay time d1 corresponds to a line delay time taken for the JPEG encoder 230 to read line data that is necessary to encode the first image frame data on a block-by-block basis.

The thumbnail image generator 240 scales the first image frame provided from the pre-processor 210 to generate thumbnail image data having a prescribed thumbnail image size and format (e.g., RGB or YUV), and outputs the generated thumbnail image data, based on the first vertical synchronization signal V_sync1 and the valid data enable signal H_ref3.

Here, the thumbnail image data may be output after a delay time d2 lapses from the falling edge of the first vertical synchronization signal V_sync1. The delay time d2 corresponds to a pre-processing time in the pre-processor 210.

Here, the vertical synchronization signal V_sync may be provided from the image sensor 100 and have the same period.

FIG. 4 is a timing diagram illustrating an output of the image signal processor, including an output 607 of the pro-processor and an output 609 of the output controller, according to an example embodiment of the present invention.

Referring to FIG. 4, the preprocessor 210 outputs the first pre-processed image frame data, based on the first vertical synchronization signal V_sync1.

The first image frame data are input to the JPEG encoder 230, which encodes the first received image frame data to generate the JEPG image data. The generated JPEG image data are stored in the frame memory 220 under control of the controller 250.

The first frame data output from the pre-processor 210 are also input to the thumbnail image generator 240, which scales the first image frame data to generate thumbnail image data having a prescribed thumbnail image size and format (e.g., RGB or YUV). The generated thumbnail image data are provided to the output controller 260 under control of the controller 250.

The controller 250 then controls the vertical synchronization signal such that a second vertical synchronization signal V_sync2, which is an output synchronization signal for the pre-processor 210, may not be generated and the second image frame data may not be output from the pre-processor 210.

Since the pre-processor 210 does not generate the second vertical synchronization signal V_sync2, the second image frame data are not provided from the pre-processor 210 to the JPEG encoder 230 and the thumbnail image generator 240. Accordingly, the JPEG image data and the thumbnail image data are not output from the JPEG encoder 230 and the thumbnail image generator 240 as shown in FIG. 3.

That is, the controller 250 controls the thumbnail image data and the JPEG image data such that the thumbnail image data for the first image frame are not provided to the output controller 260 based on the first vertical synchronization signal V_sync1 and the JPEG image data for the first image frame may be stored into the frame memory 220 based on the first vertical synchronization signal V_sync1, so that the JPEG image data encoded by the JPEG encoder 230 and the thumbnail image data generated by the thumbnail image generator 240 may be continuously output in real time, and controls the vertical synchronization signal such that the second vertical synchronization signal V_sync2 may not be generated, thereby preventing a new image frame from being output from the pre-processor 210 before the thumbnail image data and the JPEG image data for the first frame are both output via the output controller 260.

The output controller 260 outputs the thumbnail image data for the first image frame provided from the thumbnail image generator 240, based on the first vertical synchronization signal V_sync1, and determines whether the JPEG image data obtained by encoding the first image frame has been stored in the frame memory 220, when the thumbnail image data have been output.

Here, a fixed size of the thumbnail image data enables the output controller 260 to determine whether the thumbnail image data has been output.

When it is determined that the JPEG image data has been stored in the frame memory 220, the output controller 260 generates a third, new vertical synchronization control signal V_sync3 and a valid data enable signal H_ref6, reads the JPEG image data from the frame memory 220, and outputs the JPEG image data synchronized to the third generated vertical synchronization control signal V_sync3 and the valid data enable signal H_ref6.

Although, in FIG. 4, the thumbnail image data are first output and the JPEG data in the frame memory 220 are then output, based on the first vertical synchronization signal V_sync1, it will be easily appreciated by those skilled in the art that the JPEG image data for the first image frame may be first output and the thumbnail image data for the first image frame may be then output, based on the first vertical synchronization signal V_sync1.

That is, the controller 250 may provide the JPEG image data for the first image frame generated by the JPEG encoder 230 to the output controller 260 and store the thumbnail image data for the first image frame generated by the thumbnail image generator 240 in the frame memory 220, based on the first vertical synchronization signal V_sync1. The output controller 260 may output the JPEG image data based on the first vertical synchronization signal V_sync1, determine whether the thumbnail image data has been stored in the frame memory 220, generate the third, new vertical synchronization signal V_sync3 and the valid data enable signal H_ref6, and output the read thumbnail image data based on the third vertical synchronization signal V_sync3 and the valid data enable signal H_ref6.

Although, in FIG. 4, the thumbnail image data for the first image frame are output based on the first vertical synchronization signal V_sync1 and the JPEG image data are output based on the third, new vertical synchronization control signal V_sync3, the thumbnail image data for the first image frame may be output based on the first vertical synchronization signal V_sync1 and the JPEG image data for the first image frame may be subsequently output.

In the method of processing an image signal according to an example embodiment of the present invention as shown in FIG. 4, the image signal processor 200 simultaneously outputs the JPEG image data and the thumbnail image data for the first image frame, and does not generate the second vertical synchronization signal V_sync2 subsequent to the first vertical synchronization signal V_sync1, thereby preventing JPEG image data and thumbnail image data for a new image frame from being generated while the JPEG image data and the thumbnail image data for the first image frame are being continuously output.

The thumbnail image data output from the image signal processor 200 are directly provided to the display unit 500 under the control of the back-end processor 300, such that the photographed image can be displayed on a screen in real time. Furthermore, the JPEG image data output continuously with the thumbnail image data by the image signal processor 200 can be stored in the storage unit 400 or decoded and displayed on the display unit 500 under control of the back-end processor 300.

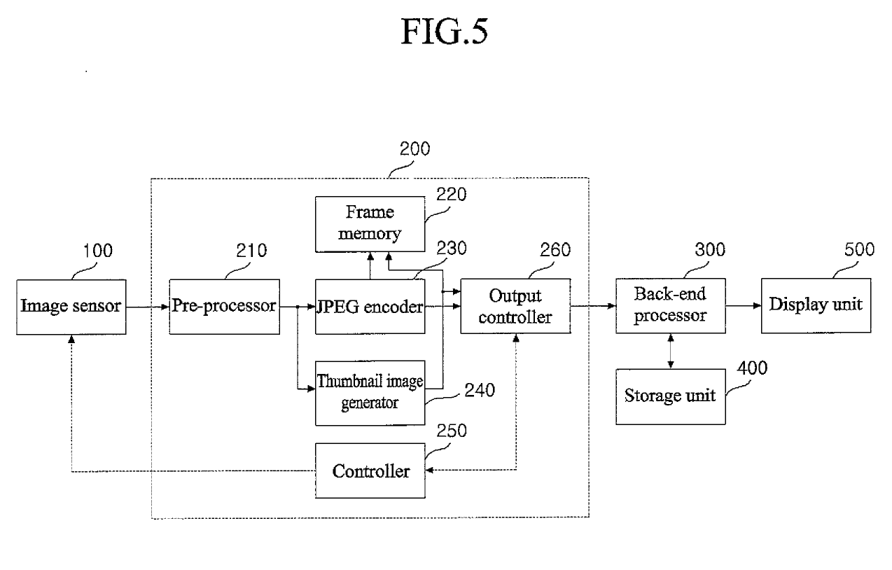

FIG. 5 is a block diagram of an imaging device according to another example embodiment of the present invention.

Referring to FIG. 5, the imaging device according to another example embodiment of the present invention includes an image sensor 100, an image signal processor 200, a back-end processor 300, a storage unit 400, and a display unit 500.

The image signal processor 200 includes a pre-processor 210, a frame memory 220, a JPEG encoder 230, a thumbnail image generator 240, a controller 250, and an output controller 260.

The image sensor 100 may be a Charge Coupled Device (CCD) or Complementary Metal-Oxide Semiconductor (CMOS) image sensor and may have a Bayer pattern. The image sensor 100 includes a plurality of pixels, each outputting raw image data corresponding to an amount of light that is input via a lens.

The image sensor 100 outputs the photographed image data on a frame-by-frame basis, based on a falling or negative edge of a vertical synchronization signal adjusted by the controller 250 or the output controller 260.

The pre-processor 210 receives the raw image data from the image sensor 100, performs pre-processing, such as color space transformation, filtering, color sub-sampling, and the like, on the received raw image data, and provides the processed image data to the JPEG encoder 230 and the thumbnail image generator 240.

Here, the pre-processor 210 synchronizes the processed image data to the vertical synchronization signal and the valid data enable signal, and provides the resultant image data to the JPEG encoder 230 and the thumbnail image generator 240 on a frame-by-frame basis.

The frame memory 220 temporarily stores JPEG image data output from the JPEG encoder 230 or thumbnail image data output from the thumbnail image generator 240, under control of the controller 250.

The JPEG encoder 230 encodes the raw image data provided from the preprocessor 210 to generate a JPEG-compressed image.

That is, the JPEG encoder 230 performs Discrete Cosine Transform (DCT), quantization, entropy encoding, and the like on the image data on a block by block basis (e.g., 8×8 pixels) to generate the JPEG image data. The JPEG encoder 230 may store the generated JPEG image data in the frame memory 220 or provide the generated JPEG image data to the output controller 260, under control of the controller 250.

The thumbnail image generator 240 scales the raw image data provided from the pre-processor 210 to transform the raw image data to have a prescribed thumbnail image size and format. The thumbnail image generator 240 may include an image scaler to generate a thumbnail image The thumbnail image format may be an RGB or YUV format.

The thumbnail image generated by the thumbnail image generator 240 may be provided to the output controller 260 or stored in the frame memory 220, under control of the controller 250.

The controller 250 controls the JPEG image data and/or the thumbnail image data being provided to the output controller 260.

Specifically, the controller 250 controls to provide the thumbnail image data for the first image frame generated by the thumbnail image generator 240 to the output controller 260 and store the JPEG image data for the first image frame generated by the JPEG encoder 230 in the frame memory 220, based on the first vertical synchronization signal.

Alternatively, the controller 250 controls the thumbnail image data and the JPEG image data such that the thumbnail image data for the first image frame may be stored in the frame memory 220 based on the first vertical synchronization signal or the JPEG image data for the first image frame may be provided to the output controller 260 based on the first vertical synchronization signal.

When a second vertical synchronization signal subsequent to the first vertical synchronization signal is generated before the thumbnail image data and the JPEG image for the first image frame data have been output, the controller 250 extends a high level of the second vertical synchronization signal that is an output synchronization signal for the image sensor 100 until the thumbnail image data and the JPEG image data are output via the output controller 260, in order to delay a falling or negative edge, i.e., a transition from a high level to a low level, thereby preventing the second image frame synchronized to the falling edge of the second vertical synchronization signal from being provided from the image sensor 100 to the image signal processor 200 before the thumbnail image data and the JPEG image data have been output from the image signal processor 200.

The falling edge of the second vertical synchronization signal is a triggering edge for synchronization enabling the second image frame to be input from the image sensor 100 to the preprocessor 210.

Here, the controller 250 can determine whether the thumbnail image data and the JPEG image data have been output, based on information indicating that the thumbnail image data and the JPEG image data have been output (e.g., information indicating generation of a new vertical synchronization signal), which is obtained from the output controller 260, and makes the level of the second vertical synchronization signal transition in synchronization with the falling edge of the new vertical synchronization signal (i.e., synchronizes the falling edges).

The output controller 260 serves to control a final output of the image signal processor 200 in cooperation with the controller 250. That is, the output controller 260 outputs the thumbnail image data for the first image frame based on the first vertical synchronization signal, determines whether the JPEG image data for the first image frame has been stored in the frame memory 220, reads the JPEG image data for the first image frame from the frame memory 220 when it is determined that the JPEG image data has been stored, and outputs the JPEG image data following the thumbnail image data.

Here, a fixed size of the thumbnail image data enables the output controller 260 to determine whether the thumbnail image data have been output. The output controller 260 may also determine whether the JPEG image data have been output, based on a marker (e.g., End Of Image (EOI)) contained in the JPEG image data.

When the thumbnail image data and the JPEG image data for the first image frame have been output, the output controller 260 generates a new vertical synchronization signal. That is, when it is determined that the thumbnail image data and JPEG image data for the first image frame have been output, the output controller 260 generates the new vertical synchronization signal and synchronizes the falling edge of the second vertical synchronization signal for the image sensor 100 to a falling edge of the new vertical synchronization signal, so that the second image frame from the image sensor 100 can be provided to the pre-processor 210 of the image signal processor 200.

When the thumbnail image data and the JPEG image data for the first image frame have been output the output controller 260 provides completion information to the controller 250, so that the controller 250 synchronizes the falling edge of the new vertical synchronization signal to the falling edge of the second vertical synchronization signal or so that the output controller 260 synchronizes the falling edge of the second vertical synchronization signal to the falling edge of the new vertical synchronization signal by directly controlling the second vertical synchronization signal.

The back-end processor 300 receives the JPEG image data from the output controller 260, and stores the received JPEG image data in the storage unit 400 or decodes the received JPEG image data and provides the decoded JPEG image data to the display unit 500 so that the JPEG image data may be displayed.

The back-end processor 300 also receives the thumbnail image data from the output controller 260, and provides the received thumbnail image data to the display unit 500 to directly display the thumbnail image data or encodes the thumbnail image data to have a JPEG format and stores the resultant data in the storage unit 400.

The back-end processor 300 includes a vertical synchronization signal V_sync, a valid data enable signal H_ref, and data interface to receive the JPEG image data and the thumbnail image data from the output controller 260 as described above, like a conventional back-end processor.

Accordingly, the image signal processor according to an example embodiment of the present invention can provide the JPEG image data and the thumbnail image data to the back-end processor via the same interface as a conventional one, in real time.

The storage unit 400 stores the JPEG image data and/or the thumbnail image data, under control of the back-end processor 300.

The display unit 500 may be, for example, a liquid crystal display (LCD) or an Organic Light Emitting Diode (OLED), and displays the JPEG image or the thumbnail image provided from the back-end processor 300.

As shown in FIG. 5, when a second vertical synchronization signal is generated while the thumbnail image data and the JPEG image for the first image frame are being output based on the first vertical synchronization signal, the image signal processor according to another example embodiment of the present invention extends a high level of the second vertical synchronization signal until the thumbnail image data and the JPEG image are output, in order to delay the falling edge, thereby preventing a new image frame (i.e., the second image frame) from being input to the image signal processor before the thumbnail image data and the JPEG image for the first image frame have been output.

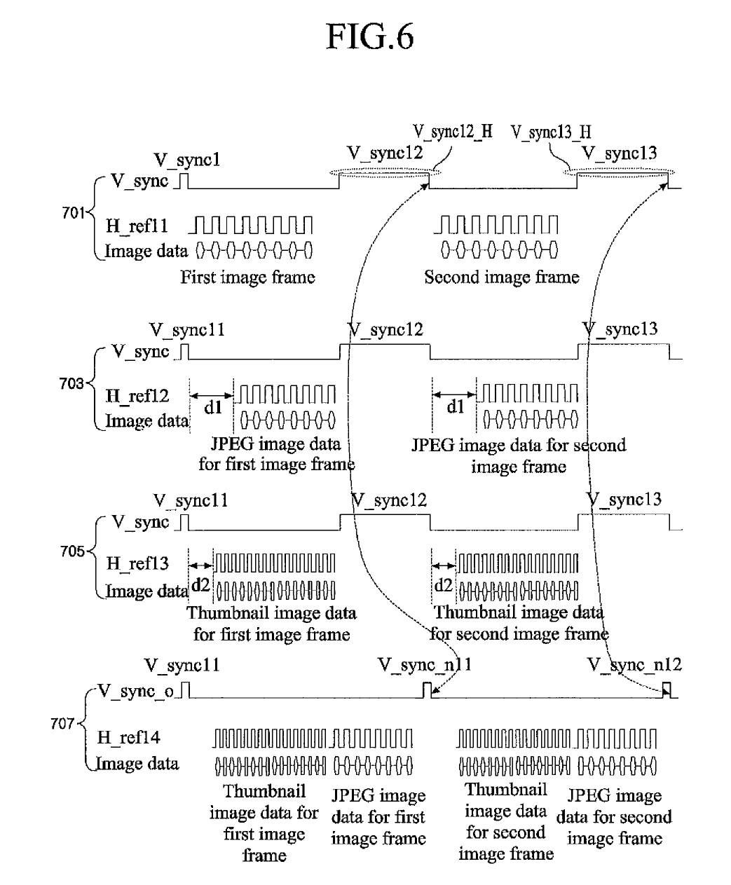

FIG. 6 is a timing diagram illustrating operation of the image signal processor, including an output 701 of the image sensor, an output 703 of the JPEG encoder, an output 705 of the thumbnail image generator, and an output 707 of the output controller, according to another example embodiment of the present invention. In FIG. 6, a timing diagram illustrating the output 701 of the image sensor is the same as an input timing diagram of the pre-processor 210.

Referring to FIG. 6, the image sensor 100 provides the first image frame data to the pre-processor 210, based on the falling edge of the first vertical synchronization signal V_sync11 and the valid data enable signal H_ref11, and the pre-processor 210 performs predetermined pre-processing and provides the first pre-processed image frame data to the JPEG encoder 230 and the thumbnail image generator 240 (701).

The JPEG encoder 230 encodes the first image frame provided from the pre-processor 210 to generate the JPEG image data, and outputs the generated JPEG image data synchronized to the first vertical synchronization signal V_sync11 and the valid data enable signal H_ref12 (703).

The JPEG image data for the first image frame output from the JPEG encoder 230 are stored in the frame memory under control of the controller 250.

Here, the JPEG image data may be output after a delay time d1 lapses from the falling edge of the first vertical synchronization signal V_sync11. The delay time d1 corresponds to a line delay time taken for the JPEG encoder 230 to read line data necessary to encode the first image frame data on a block-by-block basis.

The thumbnail image generator 240 scales the first image frame provided from the pre-processor 210 to generate thumbnail image data having a prescribed thumbnail image size and format (e.g., RGB or YUV), and outputs the generated thumbnail image data based on the first vertical synchronization signal V_sync11 and the valid data enable signal H_ref13 (705).

The thumbnail image data for the first image frame output from the thumbnail image generator 240 may be provided to the output controller 260 under control of the controller 250.

Here, the thumbnail image data may be output after a delay time d2 lapses from the falling edge of the first vertical synchronization signal V_sync11. The delay time d2 corresponds to a pre-processing time in the pre-processor 210.

The vertical synchronization signal V_sync may be provided from the image sensor 100. Since the vertical synchronization signal V_sync has a low level corresponding to a read time for the image frame, the vertical synchronization signal V sync may have the same duration.

The output controller 260 outputs the thumbnail image data for the first image frame provided from the thumbnail image generator 240, based on the first vertical synchronization signal V_sync11, and then determines whether the JPEG image data obtained by encoding the first image frame has been stored in the frame memory 220 when the thumbnail image data has been output.

Here, a fixed size of the thumbnail image data enables the output controller 260 to determine whether the thumbnail image data has been output.

When it is determined that the JPEG image data has been stored in the frame memory 220, the output controller 260 reads the JPEG image data from the frame memory 220 and outputs the JPEG image data following the thumbnail image data.

When it is determined that the thumbnail image data and the JPEG image data for the first frame have been output, the output controller 260 may indicate output completion, and generate a vertical synchronization signal V_synch_n11 for outputting the thumbnail image data and the JPEG image data for the second image frame.

Here, the output controller 260 may recognize a start and an end of the JPEG image data and determine whether the JPEG image has been output, based on a marker contained in the JPEG image data (e.g., a Start Of Image (SOI) and an End Of Image (EOI)).

When a rising edge (i.e., a transition from a low level to a high level) of the second vertical synchronization signal is generated from the image sensor while the thumbnail image data and the JPEG image for the first image frame data are being output via the output controller 260 as described above, the controller 250 extends a high level V_sync12_H of the second vertical synchronization signal to the falling edge of the vertical synchronization signal V_sync_n11 and makes the second vertical synchronization signal transition to a low level (i.e., a falling edge), thereby preventing the second image frame data from being input to the pre-processor 210 before the thumbnail image data and the JPEG image for the first image frame data have been output.

The second image frame data are then input from the image sensor 100 to the pre-processor 210 based on the falling edge of the second vertical synchronization signal V_sync12. The JPEG encoder 230 and the thumbnail image generator 240 generate the JPEG image data and the thumbnail image data for the second image frame and output the JPEG image data and the thumbnail image data based on the second vertical synchronization signal V_sync12, respectively.

The JPEG image data for the second image frame may be stored in the frame memory 220 under control of the controller 250, and the thumbnail image data for the second image frame may be provided to the output controller 260 under control of the controller 250.

The output controller 260 outputs the thumbnail image data for the second image frame based on the second vertical synchronization signal V_sync12, and then reads the JPEG image data from the frame memory 220 and outputs the JPEG image data following the thumbnail image data when it is determined that the JPEG image data for the second image frame has been stored in the frame memory 220.

When it is determined that the thumbnail image data and JPEG image data for the second frame have been output, the output controller 260 indicates output completion and generates a vertical synchronization signal V_sync_n12 for outputting thumbnail image data and JPEG image data for a next image frame.

When a rising edge of the third vertical synchronization signal V_sync13 is generated by the image sensor 100 while the thumbnail image data and the JPEG image data for the second image frame are being output via the output controller 260 as described above, the controller 250 extends a high level V_sync13_H of the third vertical synchronization signal V_sync13 to the falling edge of the vertical synchronization signal V_sync_n12, thereby preventing next image frame data from being input to the pre-processor 210 before the thumbnail image data and the JPEG image data for the second image frame have been output.

Although, in FIG. 6, the thumbnail image data synchronized to the vertical synchronization signal V_sync are first output and the JPEG data in the frame memory 220 are then output, it will be easily appreciated by those skilled in the art that in still another example embodiment of the present invention, the JPEG image data synchronized to the vertical synchronization signal V_sync may be first output and the thumbnail image data may be then output.

For example, the controller 250 may provide the JPEG image data for the first image frame to the output controller 260 based on the first vertical synchronization signal V_sync11, and simultaneously store the thumbnail image data for the first image frame in the frame memory 220. The output controller 260 may output the JPEG image data based on the first vertical synchronization signal V_sync11, read the thumbnail image data from the frame memory 220, and output the thumbnail image data following the JPEG image data.

As shown in FIG. 6, in the method of processing an image signal according to another example embodiment of the present invention, the output controller sequentially outputs the thumbnail image data and the JPEG image for the first image frame data based on the first vertical synchronization signal and then generates a new vertical synchronization signal. The controller delays the falling edge of the second vertical synchronization signal generated before the thumbnail image data and the JPEG image for the first image frame data have been output, to the falling edge of the vertical synchronization signal generated by the output controller, thereby preventing the second image frame data from being input to the image signal processor before the thumbnail image data and the JPEG data for the first image frame have been output.

Thus, JPEG image data and thumbnail image data for a given image frame can be sequentially output without eliminating a process of causing the second vertical synchronization signal not to be generated, resulting in an enhanced frame rate.

In a conventional imaging device, a photographed image with a predetermined image format (e.g., a JPEG format) is stored and checked by decoding and displaying the image or by reading the stored image and generating and displaying a thumbnail image, which increases processing time and prevents checking of the photographed image in real time. However, in the method of processing an image signal according to the example embodiments of the present invention, both the JPEG image and the thumbnail image for the photographed image frame are generated, sequentially output, and displayed on the screen in real time, thus allowing for photographing an image while checking the image in real time.

According to a method of processing a photographed image signal and a signal processing device configured to perform the same, both JPEG image data and thumbnail image data for a first image frame provided by a pre-processor are generated, the generated thumbnail image data synchronized to a first vertical synchronization signal are output, and the JPEG image data are stored in a frame memory. Here, a second vertical synchronization signal following the first vertical synchronization signal is not generated so that a second image frame is prevented from being input before the thumbnail image data and the JPEG image data for the first image frame have been output. When the thumbnail image has been output and the JPEG image has been stored in the frame memory, a new vertical synchronization signal is generated and JPEG image data synchronized to the generated vertical synchronization signal are output.

Alternatively, when the second vertical synchronization signal is generated while the thumbnail image data and the JPEG image data for the first image frame are being output based on the first vertical synchronization signal, a high level of the second vertical synchronization signal is extended until the thumbnail image data and the JPEG image data are output, in order to delay the falling edge, thereby preventing a new image frame (i.e., the second image frame) from being input to the image signal processor before the thumbnail image data and the JPEG image data for the first image frame have been output.

Thus, both the JPEG image and the thumbnail image for the photographed image are generated upon photographing and continuously provided to a back-end processor in real time, thereby allowing the thumbnail image to be displayed in real time. This enables checking of an image to be photographed before photographing.

Furthermore, the JPEG image and the thumbnail image for the photographed image are generated by the image signal processor, thereby lessening a work load of the processor and improving image processing speed.

While the invention has been shown and described with reference to certain example embodiments thereof, it will be understood by those skilled in the art that various changes in form and details may be made therein without departing from the spirit and scope of the invention as defined by the appended claims.

What is claimed is:

1. A method of processing an image signal by processing image frames provided from an image sensor and providing the processed image frames to a processor, the method comprising:
performing first image processing on a first image frame to generate first image data;
performing second image processing on the first image frame to generate second image data;
outputting the first image data based on a first vertical synchronization signal;
causing image processing not to be performed on a second image frame subsequent to the first image frame; and
outputting the second image data.

2. The method of claim 1, wherein the performing of the first image processing on a first image frame to generate first image data comprises generating the first image data scaled down by scaling the first image frame.

3. The method of claim 1, wherein the performing of the second image processing on the first image frame to generate second image data comprises encoding the first image frame to generate the second image data compressed into a predetermined format.

4. The method of claim 1, wherein the outputting of the first image data based on a first vertical synchronization signal comprises temporarily storing the second generated image data.

5. The method of claim 1, further comprising outputting the second image data based on a third vertical synchronization signal for outputting the second image data after the first image data are output.

6. The method of claim 5, wherein the outputting of the second image data based on a third vertical synchronization signal comprises:
determining whether the first image data have been output;
determining whether the second image data have been stored when the first image data has been output; and
outputting the second image data based on the third vertical synchronization signal when the second image data have been stored.

7. A method of processing an image signal by processing image frames provided from an image sensor and providing the processed image frames to a processor, the method comprising:
performing first image processing on a first image frame to generate first image data;
performing second image processing on the first image frame to generate second image data;
sequentially outputting the first and second image data; and
blocking a second image frame from being input while the first and second image data are output and receiving the second image frame when the first and second image data have been output.

8. The method of claim 7, wherein the sequentially outputting the first and second image data comprises:
outputting the first image data based on a first vertical synchronization signal;
storing the second image data; and
when the first image data has been output, reading the second stored image data and outputting the second image data following the first image data.

9. The method of claim 7, wherein the receiving of the second image frame when the first and second image data have been output comprises generating a new vertical synchronization signal when the first and second image data have been output.

10. The method of claim 7, wherein the receiving of the second image frame when the first and second image data have been output comprises: when a second vertical synchronization signal that is an input synchronization signal for the second image frame is generated while the first and second image data are being sequentially output based on the first vertical synchronization signal, delaying the second vertical synchronization signal to correspond to a vertical synchronization signal indicating that the second image data has been output, such that the second image frame may be blocked from being input while the first and second image data are being output.

11. A signal processing device for processing image frames provided from an image sensor and providing the processed image frames to a processor, the signal processing device comprising:
a first signal processor configured to perform first image processing on a first image frame to generate first image data;
a second signal processor configured to perform second image processing on the first image frame to generate second image data;
a controller configured to perform control operation such that the first image data may be output based on a first vertical synchronization signal and image processing may not be performed on a second image frame subsequent to the first image frame; and
an output controller configured to output the first and second image data respectively provided from the first and second signal processors.

12. The signal processing device of claim 11, further comprising:
a pre-processor configured to output the first image frame based on the first vertical synchronization signal; and
a frame memory configured to store the second image data under control of the controller.

13. The signal processing device of claim 12, wherein the controller perform control operation such that the first image data may be output based on the first vertical synchronization signal and the second image data may be stored in the frame memory.

14. The signal processing device of claim 12, wherein when the first image data have been output and then the second image data have been stored in the frame memory, the output controller reads the second image data from the frame memory based on a third vertical synchronization signal and then outputs the second read image data based on the third vertical synchronization signal.

15. The signal processing device of claim 11, wherein the first signal processor generates the first image data scaled down by scaling the first image frame.

16. The signal processing device of claim 11, wherein the second signal processor encodes the first image frame to generate second image data compressed into a predetermined format.

17. A signal processing device for processing image frames provided from an image sensor and providing the processed image frames to a processor, the signal processing device comprising:
a first signal processor configured to perform first image processing on a first image frame to generate first image data;
a second signal processor configured to perform second image processing on the first image frame to generate second image data;
an output controller configured to sequentially output the first and second image data; and
a controller configured to perform control operation such that a second image frame may be blocked from being input while the first and second image data are being output and the second image frame may be input after the first and second image data have been output.

18. The signal processing device of claim 17, further comprising:
a pre-processor configured to receive the first image frame from the image sensor, configured to perform predetermined pre-processing, and configured to provide the first pre-processed image frame to the first and second signal processors; and
a frame memory configured to store the second image data under control of the controller, wherein the controller perform control operation such that the first image data may be provided to the output controller and the second image data may be stored in the frame memory, based on the first vertical synchronization signal.

19. The signal processing device of claim 17, wherein the output controller outputs the first image data based on the first vertical synchronization signal, reads the second stored image data, outputs the second image data following the first image data, and generates a new vertical synchronization signal when the first and second image data have been output.

20. The signal processing device of claim 17, wherein when a second vertical synchronization signal that is an input synchronization signal for the second image frame is generated while the first and second image data are being sequentially output based on the first vertical synchronization signal, the controller delays the second vertical synchronization signal to correspond to a vertical synchronization signal indicating that the second image data have been output, such that the second image frame may be blocked from being input while the first and second image data are being output.
